(19) United States
(12) Patent Application Publication
(10) Pub. No.: US 2019/0134965 A1
(43) Pub. Date: May 9, 2019

(54) POLYETHYLENE SHINGLE WRAP

(71) Applicant: NOVA Chemicals (International) S.A., Fribourg (CH)

(72) Inventors: Fraser Waldie, Calgary (CA); Tony Tikuisis, Calgary (CA); P. Scott Chisholm, Calgary (CA)

(73) Assignee: NOVA Chemicals (International) S.A., Fribourg (CH)

(21) Appl. No.: 15/998,450

(22) Filed: Aug. 15, 2018

(30) Foreign Application Priority Data
Aug. 15, 2017 (CA) 2976254

(51) Int. Cl. B32B 27/32; B32B 27/18; B32B 27/08; B65D 65/40

(52) U.S. Cl. CPC B32B 27/32; B32B 27/18; B32B 2419/06; B65D 65/40; B32B 2439/00; B32B 27/08

(57) ABSTRACT

Asphalt shingles are commonly sold in a package that is prepared from polyethylene film. The packages are prone to premature failure after prolonged exposure to ultraviolet (UV) radiation. It has now been found that the addition of carbon black to the film can improve the UV resistance life of polyethylene packaging for asphalt shingles.

The stabilization of polyethylene (PE) films for use in shingle wrap applications is particularly challenging. Films for this application require long-term stabilization (up to 2 years) in outdoor conditions which include exposure to ultra violet (UV) radiation. The films typically contain a Hindered Amine Light Stabilizer (HALS) and a white pigment in order to provide extended protection against UV radiation. However, these films often fail within a year, especially at the point where asphalt/bitumen from the shingle is in contact with the film, suggesting that the HALS may be susceptible to poisoning by acidic chemicals which are commonly found in the asphalt of shingles.

In an embodiment, the present invention provides: a polyethylene film in contact with an asphalt shingle, said polyethylene film being prepared from a polyethylene composition containing from 70 to 100 weight % of at least one linear ethylene copolymer and wherein said polyethylene film comprises a stabilizer package comprising:

1) a hindered amine light stabilizer; and

2) carbon black.

In another embodiment, the invention provides:

a multilayer polymeric film having a total thickness of from 1.5 to 4 mils, said film having A) an inner layer that is in contact with an asphalt shingle and B) at least one additional layer wherein said inner layer is prepared from a polyethylene composition containing from 70 to 100 weight % of at least one linear ethylene copolymer and wherein said additional layer comprises a stabilizer package comprising:

1) a hindered amine light stabilizer; and

2) carbon black.

In another embodiment, the invention provides:

a package containing asphalt shingles wherein said package is made from a polyethylene film being prepared from a polyethylene composition comprising from 70 to 100 weight % of at least one linear ethylene copolymer and wherein said polyethylene film comprises a stabilizer package comprising:

1) a hindered amine light stabilizer; and

2) carbon black

and wherein at least one of said asphalt shingles is in contact with said polyethylene film.

The polyethylene film of this invention must contain carbon black (CB). Carbon black is known to reduce the rate of UV-induced degradation in polymers, with the addition of carbon black to the rubber used to make automotive tires being a common example. However, other particulate fillers (such as titanium oxide and zinc oxide) are also commonly used to provide UV protection but have been found to be less effective for shingle wrap. While not wishing to be bound by theory, it is postulated that the CB may absorb residual hydrocarbons from the asphalt (e.g. xylenes) which can lead to stress cracking and failures of the PE film.

### Linear Polyethylene

The term “linear polyethylene” generally refers to a polyethylene that is prepared with a transition metal catalyst. This definition does encompass a wide variety of commercially available polyethylene products but it excludes a type of polyethylene that is prepared in a high pressure reactor with a free radical initiator (which polyethylene is typically referred to as “high pressure/low density” polyethylene).

The term “linear polyethylene copolymer” further requires that the polyethylene is a copolymer of ethylene with at least one other alpha olefin such as butene, pentene, hexene, heptene, or octene.

The preferred linear polyethylene copolymers used in this invention have a melt index, “I₂”, as determined by ASTM D 1238 (using a 2.16 kg weight, at a temperature of 190° C.) of from 0.1 to 20 grams per 10 minutes (for example from 0.5 to 3 grams per 10 minutes) and a density of 0.890 to 0.955 grams per cubic centimeter (g/cc), for example from 0.910 to 0.930 g/cc.

The linear polyethylenes may be produced in any of the known polymerization processes (such as a gas phase process, a slurry process or a solution process) using any known polymerization catalyst that contains a transition metal (such as a chromium catalyst, a Ziegler Natta catalyst or a single site catalyst such as a metallocene catalyst or a so-called “constrained geometry catalyst”.

### Polyethylene Composition

The polyethylene composition that is in contact with the shingle contains from 70 to 100 weight % of the above described linear ethylene copolymer. In an embodiment, the polyethylene composition contains a blend of more than one linear ethylene copolymer (with the requirement that the total amount of linear ethylene copolymer is from 70 to 100% by weight of the polyethylene composition). In an embodiment, the polyethylene composition contains from 5 to 30 weight % of the previously described “high pressure/low density polyethylene” as it is known that such a blend can be easier to process than a 100 weight % linear ethylene copolymer composition. For clarity: the use of more than 30 weight % “high pressure/low density polyethylene” is not encompassed by this invention, but the use of 30 weight % or less is contemplated.

### HALS

The additives packages disclosed herein comprise at least one HALS.

HALS are well known to those skilled in the art.

Non limiting examples of suitable HALS include: bis (2,2,6,6-tetramethylpiperidyl)-sebacate; bis-5 (1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylenediamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone).

In some embodiments the HALS is preferably a commercially available material and is used in a conventional manner and amount.

Commercially available HALS include those sold under the trademarks CHIMASSORB® 119; CHIMASSORB 944; CHIMASSORB 2020; TINUVIN® 622 and TINUVIN 770 from BASF (formally Ciba Specialty Chemicals Corporation), and CYASORB® UV 3346, CYASORB UV 3529, CYASORB UV 4801, and CYASORB UV 4802 from Cytec Industries. In some embodiments, TINUVIN 622 is preferred. Mixtures of more than one HALS are also contemplated.

In an embodiment, the amount of HALS is from 500 to 5000 parts per million by weight (for example from 1000 to 3000 parts per million), based on the weight of the polyethylene composition.

### Carbon Black

A wide variety of different carbon blacks are suitable for use in this invention. In an embodiment, the carbon black is a commercially available product that is recommended for use as an additive or filler for plastics. Non limiting examples include the family of carbon black products sold under the name BLACK PEARLS by Cabot Corporation. The amount of carbon black may be from 5,000 to 50,000 parts per million by weight (for example from 10,000 to 30,000) based on the weight of the polyethylene composition.

### Zinc Oxide

In an embodiment this invention provides a multilayer film in which at least one layer contains carbon black and at least one layer contains zinc oxide (for example in an amount of from 1,000 to 10,000 ppm).

ZnO is widely used as a polyolefin additive. Any of the commercially available ZnO products that are presently used in polyolefins are potentially suitable, including so called “nano” ZnO (which ZnO has an especially small, or “nano” particle size).

### Other Additives

The compositions of this invention may optionally include other additives that are conventionally used with polyethylene. Typical polyethylene additives are described below, starting with phosphite antioxidants.

### Phosphite Antioxidant

The term phosphite antioxidant includes monophosphites, diphosphites, and mixed phosphites, all of which are commonly used with polyethylene. Non limiting examples of monophosphites include: tris nonyl phenyl phosphite (TNPP) and 2,4 di tertiary butyl phosphite (sold under the tradename IRGAFOS® 168).

As used herein, the term diphosphite refers to a phosphite stabilizer which contains at least two phosphorus atoms per phosphite molecule.

Non limiting examples of suitable diphosphites and diphosphonites follow: distearyl pentaerythritol diphosphite, diisodecyl pentaerythritol diphosphite, bis(2,4 di-tert-butylphenyl) pentaerythritol diphosphite [sold under the Trademark ULTRANOX® 626, by Chemtura Corporation]; bis(2,6-di-tert-butyl-4-methylphenyl) pentaerythritol diphosphite; bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, and bis(2,4-dicumylphenyl)pentaerythritol diphosphite [sold under the Trademarks DOVERPHOS® S9228-T and DOVERPHOS S9228-CT by Dover Chemicals Corporation].

The term “mixed phosphites” includes the product sold as Weston 705 (CAS Registry #939402-02-5) which is reported to be mixed esters of phosphorous acid.

The monophosphate, diphosphate, or mixed phosphites (or blends thereof) may be used in amounts of from 200 ppm to 2,000 ppm, for example from 400 to 1,000 ppm.

### Acid Neutralizers

Many commercially available polyolefins contain chloride residues. These chloride residues may generate hydrochloric acid, particularly during melt processing operations. Accordingly, an “acid neutralizer” is conventionally included in a polyolefin stabilization package and is, in some embodiments, preferably included in the process of this invention. These acid neutralizers may be divided into “Inorganic”—such as zinc oxide, synthetic hydrotalcites and Li, Na, Ca or Al (hydroxy) carbonates; and “Organic”—such as salts of fatty acids or their derivatives including calcium stearate, zinc stearate, calcium lactate and calcium stearoyl lactylate.

When employed, these conventional acid neutralizers are used in conventional amounts. In some embodiments, it is preferred to use a synthetic hydrotalcite (in an amount of from 100 to 1000 ppm), zinc stearate (in an amount of from 500 to 1500 ppm) or calcium stearoyl lactylate (in an amount of from 200 to 700 ppm). A combination of a hydrotalcite with an “organic” acid neutralizer is also contemplated.

### Hindered Phenolic Antioxidants

Hindered phenolic antioxidants (for example alkylated mono-phenols) are commonly used with linear polyethylene. They are also referred to as “primary” antioxidants. The hindered phenol may be used in a conventional amount of from 300 to 1500 ppm, for example from 500 to 1000 ppm.

Non limiting examples include: 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4isobutylphenol; 2,6-dicyclopentyl-4-methylphenol; 2-(.alpha.-methylcyclohexyl)-4,6 dimethylphenol; 2,6-di-octadecyl-4-methylphenol; 2,4,6,-tricyclohexyphenol; and 2,6-di-tert-butyl-4-methoxymethylphenol.

### Alkylated Hydroquinones

Non limiting examples include: 2,6di-tert-butyl-4-methoxyphenol; 2,5-di-tert-butylhydroquinone; 2,5-di-tert-amyl-hydroquinone; and 2,6diphenyl-4-octadecyloxyphenol.

### Hydroxylated Thiodiphenyl Ethers

Non limiting examples include: 2,2′-thio-bis-(6-tert-butyl-4-methylphenol); 2,2′-thio-bis-(4-octylphenol); 4,4′thio-bis-(6-tertbutyl-3-methylphenol); and 4,4′-thio-bis-(6-tert-butyl-2-methylphenol).

### Alkylidene-Bisphenols

Non limiting examples include: 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl)phenol); 2,2′-methylene-bis-(4-methyl-6-cyclohexyiphenol); 2,2′-methylene-bis-(6-nonyl-4-methylphenol); 2,2′-methylene-bis-(6-nonyl-4methylphenol); 2,2′-methylene-bis-(6-(alpha-methylbenzyl)-4-nonylphenol); 2,2′-methylene-bis-(6-(alpha, alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′methylene-bis-(2,6-di-tert-butylphenol); 4,4′-methylene-bis-(6-tert-butyl-2-methylphenol); 1,1-bis-(5-tert-butyl-4-hydroxy-2-methylphenol)butane 2,6-di-(3-tert-butyl-5-methyl-2-hydroxybenzyl)-4-methylphenol; 1,1,3-tris-(5-tert-butyl-4-hydroxy-2-methylphenyl)butane; 1,1-bis-(5-tert-butyl-4-hydroxy2-methylphenyl)-3-dodecyl-mercaptobutane; ethyleneglycol-bis-(3,3,-bis-(3′-tert-butyl-4′-hydroxyphenyl)-butyrate)-di-(3-tert-butyl-4-hydroxy-5-methylphenyl)-dicyclopentadiene; di-(2-(3′-tert-butyl-2′hydroxy-5′methylbenzyl)-6-tert-butyl-4-methylphenyl)terephthalate; and other phenolics such as monoacrylate esters of bisphenols such as ethylidiene bis-2,4-di-t-butylphenol monoacrylate ester.

### Fillers and Reinforcing Agents

Non limiting examples include: calcium carbonate; silicates; glass fibers; asbestos; talc; kaolin; mica; barium sulfate; metal oxides and hydroxides; and graphite. Titanium oxide is commonly used as a white pigment in prior art shingle wrap film. In an embodiment of this invention, an outer layer of a multilayer shingle wrap may be a white layer that contains titanium oxide (and zinc oxide).

### Hydroxylamines and Amine Oxides

Non limiting examples include: N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecylhydroxylamnine; N-heptadecyl-N-octadecylhydroxylamine; and N,N-dialkylhydroxylamine derived from hydrogenated tallow amine. The analogous amine oxides (as disclosed in U.S. Pat. No. 5,844,029, Prachu et al.) may also be employed.

### Lactones

Lactones such as benzofuranone (and derivatives thereof) or indolinone (and derivatives thereof).

### Other Miscellaneous Additives

Non limiting examples include: plasticizers; epoxidized vegetable oils, such as epoxidized soybean oils; lubricants; emulsifiers; polymer process additives (e.g. fluoroelastomers); pigments; optical brighteners; flameproofing agents; anti-static agents; and anti-blocking agents such as talc or silica.

### Melting Processing Operations

In general, any mixing/melt processing operation that is suitable for polyolefins, may be used to prepare the composition of this invention. The mixing operations are conducted at temperatures from above the melting point of the linear polyethylene copolymer to as high as 400° C. The use of an extruder (single screw or twin screw) is preferred in some embodiments.

### Preparation of Films

In a blown film process, the polyethylene is melted in a screw extruder (for example at a temperature of from 200 to 290° C., for example from 210 to 250° C.) and then forced through an annular die to form a tube of molten polyethylene. The tube is inflated with air from the interior of the tube, then cooled and finally flattened by nip rolls. It is also known to co-extrude multi layers of film by this process. In a typical coextrusion process, multiple extruders (each equipped with a die) provide multiple film layers which collectively form the film. Different polymers and/or additive formulations are often used in the different layers. Films having 3, 5, 7 and 9 layers are now in commercial use.

In an embodiment, the total thickness of the film is from 1.5 to 4 mils. In an embodiment, the film is a multilayer film having a total thickness of from 1.5 to 4 mils in which the film has

A) an inner layer that is in contact with an asphalt shingle wherein said inner layer is prepared from a first polyethylene composition comprising from 70 to 100 weight % of at least one linear ethylene copolymer and wherein said inner layer comprises a first stabilizer package comprising:
1) a hindered amine light stabilizer; and
2) carbon black; and

B) at least one additional layer.

In an embodiment, the thickness of the inner layer is at least 1 mil and less than 3.9 mils. In an embodiment, the thickness of the inner layer is at least 1 mil and less than 3.5 mils. In an embodiment, the thickness of the inner layer is at least 1 mil and less than 3 mils. In an embodiment, the thickness of the inner layer is at least 1 mil and less than 2 mils. In an embodiment, the thickness of the inner layer is 1 mil. In an embodiment, the thickness of the inner layer is 1.5 mils. In an embodiment, the thickness of the inner layer is 2 mils. In an embodiment, the thickness of the inner layer is 2.5 mils. In an embodiment, the thickness of the inner layer is 3 mils. In an embodiment, the thickness of the inner layer is 3.5 mils.

In an embodiment, the B) at least one additional layer is comprised of a single polyethylene layer prepared from a second polyethylene composition comprising from 70 to 100 weight % of at least one linear ethylene copolymer and wherein said second polyethylene composition comprises a second stabilizer package comprising:
1) a hindered amine light stabilizer; and
2) zinc oxide.

In an embodiment, the B) at least one additional layer consists of a single polyethylene layer prepared from a second polyethylene composition comprising from 70 to 100 weight % of at least one linear ethylene copolymer and wherein said second polyethylene composition comprises a second stabilizer package comprising:

1) a hindered amine light stabilizer; and

2) zinc oxide.

In an embodiment, the second stabilizer package further comprises titanium oxide and zinc oxide. In an embodiment, the second stabilizer package further comprises titanium oxide and zinc oxide, and the combined amount of titanium oxide and zinc oxide is from 5,000 to 50,000 parts by weight, based on the weight of the second polyethylene composition.

In some embodiments any one of, or any combination of, the stabilizer package(s) additionally comprises a hindered phenolic antioxidant and a phosphite antioxidant.

In a cast film process, the polyethylene is also melted in a screw extruder (for example at temperatures of from 450° F. (232° C.) to 600° F. (316° C.) for example from 500° F. (260° C.) to 550° F. (288° C.) and then forced through a flat die. The molten polyethylene web is then cooled (typically, through the use of a water bath or, alternatively, temperature controlled casting rolls).

### EXAMPLES

### Example 1

A small scale experiment were completed in order to compare the performance of various stabilizers formulations. Samples were compounded using a twin screw extruder. Compounded samples were then extruded into monolayer blown films having a thickness of 1.9 mils using a conventional blown film line (3 inch die, 35 mil die gap, 2.5:1 BUR, 40 lbs/h).

The polyethylene used in all experiments of example 1 was a linear ethylene copolymer, specifically an ethylene-octene copolymer having a density of about 0.9215 g/cc and a melt index, 12 (as determined by ASTM D1238 at 190° C., using a 2.16 kg load) of about 0.85 grams per 10 minutes. This copolymer was produced in a solution phase polymerization process using single site catalyst technology. It contained a conventional additive package (500 ppm of a hindered phenolic antioxidant sold under the tradename IRGANOX 1076 and 500 ppm of a monophosphate antioxidant sold under the tradename IRGAFOS 168). 5000 ppm of a commercially available HALS (sold under the tradename TINUVIN III) was also added to all formulations from Table 1.

TABLE 1
Additive formulations for stabilization of shingle wrap (ppm)

| Formulation | HALS | TiO₂ | ZnO | Carbon Black |
|---|---|---|---|---|
| Control | 5000 | 40.00 | | |
| 1 | 5000 | 40.00 | 7500 | |
| 2 | 5000 | 0 | | 25.000 |

A control film (without carbon black) further contained a 4% titanium dioxide (TiO₂) white pigment which is representative of a typical (prior art) shingle wrap formulation. Formulation 1 contained 7500 ppm of zinc oxide (sold under the tradename ATMER 7355 by Croda) in addition to the HALS and titanium dioxide.

Formulation 2 contained HALS and carbon black (2.5 weight % sold under the tradename BLACK PEARLS 4350 by Cabot Corporation) but did not contain ZnO or TiO₂, as shown in Table 1.

Films were then prepared from each of three formulations shown in Table 1. The films were then used to wrap asphalt shingles so that the film was in contact with the bitumen strip of a shingle (“CertainTeed” brand shingle). Duplicate samples were exposed in a weather-o-meter (WOM) and visually inspected every 250 hours for signs of failure (cracks, holes, tears, etc.).

Photographs were taken of each sample at 250 h intervals up to 2000 h of WOM exposure. Formulation 2 was the only formulation in which no holes or tears were observed after 2000 h of WOM exposure. The control film (made with TiO2) failed after 1000 hours of WOM exposure—failure was determined by the presence of cracks and open holes in the film. The film made from formulation 1 was somewhat better than the control and did not fail until 1250 hours of WOM exposure. The number of cracks in the film (and size of the holes) increased with an increase in the time of WOM exposure.

### Discussion of Experimental Results

Thin gauged PE films used for wrapping and protecting shingles during storage outdoors are inherently susceptible to accelerated degradation. While not wishing to be bound by theory, the presence of residual hydrocarbons and acidic sulfur species in the bitumen/tar of the shingles is proposed to poison conventional UV stabilizers and lead to accelerated degradation of films that are in contact with the shingles. Failures are predominantly observed where the PE film is in direct contact with bitumen/tar on the shingle. Commonly used HALS molecules are basic in nature and are vulnerable to poisoning by acidic species and molecules.

The use of carbon black has now been found to improve the UV resistance of PE films exposed to asphalt shingles. Furthermore, we have also found that the addition of zinc oxide to a conventional shingle wrap formulation (which contains titanium oxide) also provides enhanced UV resistance.

It is surprising that the film containing carbon black—and the film containing zinc oxide—both provide enhanced UV protection in comparison to the conventional shingle wrap film that contains titanium oxide. While not wishing to be bound by any particular theory, it is believed that the asphalt contains acidic species that can adversely affect the performance of the HALS additive, and that:

1) the carbon black may absorb the species; and

2) the zinc oxide may act as an acid neutralizer.

Existing shingle wrap contains titanium oxide which should provide UV protection and which also provides a white film that is easily printed. We have observed that superior UV resistance is provided by a film that contains carbon black in the layer that contacts the shingles. However, the present invention also includes a multilayer film having an inner layer (which contacts the shingles) containing carbon black and an outer layer that contains white pigment (zinc oxide and/or titanium oxide) to facilitate printing.

Existing shingle wrap packaging contains titanium oxide. Titanium oxide may provide some UV protection and it also provides a white film that is easily printed. We have also found that a white film that contains zinc oxide (and, optionally, titanium oxide) has improved UV resistance in comparison to a film that contains only titanium oxide. As noted above, the white film allows the package to be easily printed, so—in an embodiment, the present invention provides a multilayer shingle wrap film in which the inner layer (i.e. the layer in contact with the shingles) contains carbon black and at least one other layer is a white layer to facilitate printing. In an embodiment, at least one other layer contains zinc oxide, and zinc oxide has now been observed to improve UV resistance.

What is claimed is:

1. A polyethylene film in contact with an asphalt shingle, said polyethylene film being prepared from a polyethylene composition comprising from 70 to 100 weight % of at least one linear ethylene copolymer and wherein said polyethylene film comprises a stabilizer package comprising:
1) a hindered amine light stabilizer; and
2) carbon black.

2. The polyethylene film according to claim 1 wherein said stabilizer package additionally contains a hindered phenolic antioxidant and a phosphite antioxidant.

3. The polyethylene film according to claim 1 wherein said linear ethylene copolymer has a melt index, 12, as measured by ASTM D1238 of from 0.5 to 3 grams per 10 minutes and a density of from 0.910 to 0.930 g/cc.

4. The polyethylene film of claim 1 wherein said carbon black is present in an amount of from 5,000 to 50,000 parts per million by weight, based on the weight of said polyethylene composition.

5. A multilayer polymeric film having a total thickness of from 1.5 to 4 mils, said film having
A) an inner layer that is in contact with an asphalt shingle wherein said inner layer is prepared from a first polyethylene composition containing from 70 to 100 weight % of at least one linear ethylene copolymer and wherein said inner layer comprises a first stabilizer package comprising:
1. a hindered amine light stabilizer; and
2. carbon black; and
B) at least one additional layer.

6. The multilayer polymeric film of claim 5 wherein said B) at least one additional layer consists of a single polyethylene layer prepared from a second polyethylene composition comprising from 70 to 100 weight % of at least one linear ethylene copolymer and wherein said second polyethylene composition comprises a second stabilizer package comprising:
1) a hindered amine light stabilizer; and
2) zinc oxide.

7. The multilayer film of claim 6 wherein said second stabilizer further comprises titanium oxide, with the combined amount of said titanium oxide and zinc oxide being from 5000 to 50,000 parts per million by weight, based on the weight of said second polyethylene composition.

8. The multilayer film of claim 5, wherein the thickness of said inner layer is 1 mil to 3.5 mils.

9. A package adapted to contain asphalt shingles wherein said package is made from a polyethylene film according to claim 1 and wherein at least one of said asphalt shingles are in contact with said polyethylene film.

10. A package containing asphalt shingles wherein said package is made from a multilayer polymeric film according to claim 5 and wherein at least one of said asphalt shingles are in contact with said inner layer of said polymeric film.
